(19) United States
(12) Patent Application Publication
(10) Pub. No.: US 2020/0134615 A1
(43) Pub. Date: Apr. 30, 2020

(54) SYSTEM AND METHODS FOR CREATING, TRANSFERING, AND INVOKING A TRANSFERABLE PROMISE

(71) Applicant: Zhongwei Wu, Hastings On Hudson, NY (US)

(72) Inventor: Zhongwei Wu, Hastings On Hudson, NY (US)

(21) Appl. No.: 16/175,953

(22) Filed: Oct. 31, 2018

(51) Int. Cl. G06Q 20/38; H04L 9/08; H04L 9/30

(52) U.S. Cl. CPC G06Q 20/3829; H04L 9/088; G06Q 2220/00; G06Q 20/3827; H04L 9/30

(57) ABSTRACT

A transaction network comprising a plurality of party devices interconnected via a communication network, each party device corresponding to a transaction party. The transaction network facilitates localized creation and enforcement of a transferable promise involving an obligor and an owner, the obligor being required to perform an obligatory action upon the owner invoking the transferable promise. The transferable promise is encrypted and signed to protect its integrity, and is invocable only by the owner. The obligor further verifies the transferable promise upon its invocation to prevent a double-spend attempt. The transferable promise contains a continuation executed upon invocation to cause an executing device of the obligor to perform the obligatory action. The transferable promise is adapted to effect the delivery of a digital asset or digital representation of a physical asset, or the performance of a service, and may be transferred, assigned, and sold between transaction parties as an asset.

### TECHNICAL FIELD

The present disclosure relates generally to a transaction system for facilitating the transfer of assets and the performance of services. More particularly, the present disclosure relates to a decentralized transaction network for locally creating, transferring, and invoking enforceable promises between transaction parties.

### BACKGROUND

Existing payment networks are only designed to facilitate a one-way transfer of currency from the sender to the recipient. However, real world transactions generally involve the exchange of currency for goods and services, and the transfer of currency via the payment network represents only one half of the transaction. The paying party has no way to ensure that the other party will fulfill its half of the transaction, and must therefore trust the other party to deliver the promised goods or perform the promised services. Furthermore, payment networks are generally only capable of transferring currencies, and cannot directly effect the transfer of goods or the digital representation of goods.

Another problem which a payment networks must address is the prevention of double-spending, which is an attempt to exploit weaknesses in a payment network to fraudulently spend a specific asset more than once. Traditional payment networks prevent double-spending by employing a centralized trusted intermediary as a payment clearing system. For example, checks and electronic payments are processed through the Federal Reserve Payment Service, which acts as a centralized trusted party which ensures the integrity of payments made from one authenticated party to another authenticated party. However, a major disadvantage of centralization is that a centralized payment system cannot function without the trusted intermediary.

Decentralized payment networks, such as blockchain networks, do not require a centralized trusted intermediary. However, blockchain networks are fundamentally inefficient and require global consensus across all nodes in the network in order for transactions to be verified and executed. The integrity of the blockchain is maintained through a proof-of-work mechanism which is inherently redundant and competitive, leading to high transaction costs and an escalating arms race in computing power and energy use. Furthermore, blockchain networks only facilitate the one-way transfer of digital currency, and offer no solution to the problem of ensuring completion of the other half of the transaction once the payment has been delivered, especially when completion of the transaction requires the transfer of goods and services.

A need therefore exists for a decentralized network which allows transaction parties to create unique enforceable obligations to deliver not only digital assets, but goods and services, without the need for a centralized trusted intermediary. Such obligations would be secure and unalterable to ensure the integrity of the transactions, and would further be self-executing to guarantee that the obligations of all transaction parties are carried out.

In the present disclosure, where a document, act or item of knowledge is referred to or discussed, this reference or discussion is not an admission that the document, act or item of knowledge or any combination thereof was at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed and it is contemplated that the claims may encompass one or more of the conventional technical aspects discussed herein.

### BRIEF SUMMARY

An aspect of an example embodiment in the present disclosure is to provide a transaction network capable of creating enforceable promises as digital representations of assets to deliver currency, goods, and services between transaction parties. Accordingly, the present disclosure provides a transaction network comprising a plurality of party devices operably connected via a network, adapted to create a transferable promise between an obligor and an owner, and represents an enforceable obligation on the part of the obligor to perform an obligatory action for the benefit of the owner, whereby the obligatory action is the delivery of an asset or the performance of a service. Performance of the obligation is guaranteed by the obligor and occurs upon the owner invoking the transferable promise. The transferable promise is created and invoked locally between the transaction parties without any intermediaries or centralized trusted parties.

Another aspect of an example embodiment in the present disclosure is to provide a transaction network where each promise is consented to by all parties and secured against alteration or unauthorized use. Accordingly, each transaction party has a public-private key pair. Upon the transaction parties agreeing upon the obligation, the transferable promise is created and secured by the obligor. The obligor encrypts the promise using the public key of the owner, signs the promise using its own private key, and sends the secured transferable promise to the owner. Upon invoking the transferable promise, the owner un-signs the promise using the public key of the obligor, decrypts the promise using its own private key, and sends the transferable promise to the obligor. Anyone familiar with prior art will know the two-step encryption and signature process ensures the security of the promise is thus achieved. The signature of the obligor prevents tampering of the transferable promise and ensures that the obligor has consented to take on the obligation to the owner, while the encryption ensures that only the owner may validly invoke the transferable promise with the use of its private key.

Yet another aspect of an example embodiment in the present disclosure is to provide a promise which is self-contained and self-executing. Accordingly, the transferable promise contains a continuation containing parameters and a segment of code defining a program control state, which is reified upon an executing computing device of the obligor to cause the obligor to automatically perform the obligatory action upon the invocation of the transferable promise by the owner. The continuation may be adapted to facilitate the transfer of digital assets or a digital representation of physical assets from the obligor to the owner, or cause the obligor to perform the promised service.

It is a further aspect of an example embodiment in the present disclosure to provide a promise which can be transferred as an asset. Accordingly, the owner of the transferable promise may initiate a promise transfer and transfer ownership of the promise to a recipient which becomes the new owner. The obligor verifies the transferable promise being transferred and recognizes the recipient as the new owner. Furthermore, when the obligation is fungible, the obligor may assign its obligation in the transferable promise to another transaction party which is capable of performing the obligation, upon the consent of the owner.

It is yet a further aspect of an example embodiment in the present disclosure to provide a transaction network which prevents double-spend attempts. Accordingly, each transferable promise is unique, and the obligor ensures that a transferable promise that has already been invoked cannot be invoked for a second time or transferred.

It is yet a further aspect of an example embodiment in the present disclosure to provide a transaction network which allows the use of computing resources to be transferred as a promise. Accordingly, the continuation of the transferable promise may be adapted to, upon the invocation of the transferable promise, cause the obligor to calculate a complex computation problem and deliver the result to the owner, or cause the obligor to perform a storage request to store the owner's data upon a computer storage device which is made accessible to the owner.

It is yet another aspect of an example embodiment in the present disclosure to provide a transaction network which allows enforceable promises to be sold as assets. Accordingly, the transaction network may provide a promise market which facilitates the transfer of the transferable promise between the owner as a seller, and another transaction party as the buyer. The seller transfers the ownership of the transferable promise to the buyer upon the buyer delivering currency to the seller. Furthermore, the promise market may allow multiple transferable promises to be sold, and will match bids placed by buyers with offers.

It is yet a further aspect of an example embodiment in the present disclosure that both digital currency and fiat currency can be represented by a promise where the obligor keeps custody of such currencies on behalf of the owner. The advantage of the promise representation over a simple balance is that the double-spend is simply prevented by the obligor without a need for a trusted intermediary for all transactions.

It is yet a further aspect of an example embodiment in the present disclosure that a transaction can require multiple promises which entail rights and obligations for all transaction parties. This ensures that all aspects of a transaction are included together as a unit, unlike traditional transaction networks where only one aspect of a transaction such as payment is included.

The promise thus provides a mechanism for representing digital assets that is free of tampering, prevents double-spending and can be used in transactions which represent simultaneously both the payments and delivery of goods and services without relying on a trusted intermediary to carry out the transactions among a plurality of transaction parties. While there is no intermediary involved in any transaction involving promises, each transaction is secure, with third parties unable to extract the value embedded in the promises. Simultaneously, the behavior of each transaction party including owners and obligors are transparent and can be verified to be valid by any third party, thus providing recourse to any obligor failing its obligations.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

### BRIEF DESCRIPTION OF THE DRAWINGS

In the drawings, like elements are depicted by like reference numerals.

The drawings are briefly described as follows.

FIG. 1A is a block diagram depicting a transaction network of party devices interconnected via a communication network which allows a transferable promise created between an obligor and an owner to be transferred and invoked, in accordance with an embodiment of the present disclosure.

FIG. 1B is a block diagram depicting the invocation of the transferable promise by the owner which causes the obligor to perform an obligatory action, in accordance with an embodiment of the present disclosure.

FIG. 1C is a block diagram depicting a promise transfer whereby ownership of the transferable promise is transferred to a new owner, which is now entitled to invoke the transferable promise, in accordance with an embodiment of the present disclosure.

FIG. 2A is a block diagram depicting the creation of the transferable promise by the obligor, along with attributes and field which define the obligation, further depicting the obligor encrypting and signing the transferable promise, in accordance with an embodiment of the present disclosure.

FIG. 2B is a block diagram depicting the use of a paired public key and private key to sign and decrypt promises and messages being sent by a transaction party, and the use of the transaction party's public key to encrypt promises being sent to the party by another party, in accordance with an embodiment of the present disclosure.

FIG. 3 is a block diagram depicting the owner invoking and presenting the transferable promise to the obligor by first un-signing and decrypting the transferable promise, in accordance with an embodiment of the present disclosure.

FIG. 4A is a block diagram depicting a continuation, whereby the continuation uses attributes of the transferable promise as runtime environment variables which facilitate reification of the control state on the executing device to execute commands to transfer digital assets from the obligor to the owner or provide its value to the owner in some other way, in accordance with an embodiment of the present disclosure.

FIG. 4B is a block diagram depicting a continuation for performing the example service of calculating a complex computation problem by the obligor, in accordance with an embodiment of the present disclosure.

FIG. 5 is a block diagram depicting a promise transfer whereby ownership of the transferable promise is transferred from a sender to a recipient, in accordance with an embodiment of the present disclosure.

FIG. 6 is a flowchart depicting an exemplary promise creation, transfer, and invocation process, in accordance with an embodiment of the present disclosure.

FIG. 7 is a block diagram depicting an aggregated promise transfer, in which the ownership of a plurality of input transferable promises is transferred to a plurality of recipients, in accordance with an embodiment of the present disclosure.

FIG. 8A is a block diagram depicting a promise assignment, whereby the obligor of the transferable promise assigns its obligation to a recipient which becomes the new obligor, in accordance with an embodiment of the present disclosure.

FIG. 8B is a block diagram depicting netting resulting from the assignment of a transferable promise, whereby the ownership balance of the assigning party is netted against its obligation balance, in accordance with an embodiment of the present disclosure.

FIG. 9 is a block diagram depicting a promise publication by the obligor which reveals the obligation within the transferable promise to other party devices, in accordance with an embodiment of the present disclosure.

FIG. 10 is a block diagram depicting a multi-promise transaction, showing an exchange of promises such that each transaction party is simultaneously an owner as well as an obligor, in accordance with an embodiment of the present disclosure.

FIG. 11A is a block diagram depicting a promise market, allowing transferable promises to be sold for currency, in accordance with an embodiment of the present disclosure.

FIG. 11B is a block diagram depicting a promise market transaction implemented as a multi-promise transaction, with the transferable promise being transferred to the buyer, in exchange for the buyer delivering currency to the seller in the form of another transferable promise, in accordance with an embodiment of the present disclosure.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete and fully conveys the scope of the present disclosure to those skilled in the art.

### DETAILED DESCRIPTION OF THE PREFERRED EMBODIMENTS

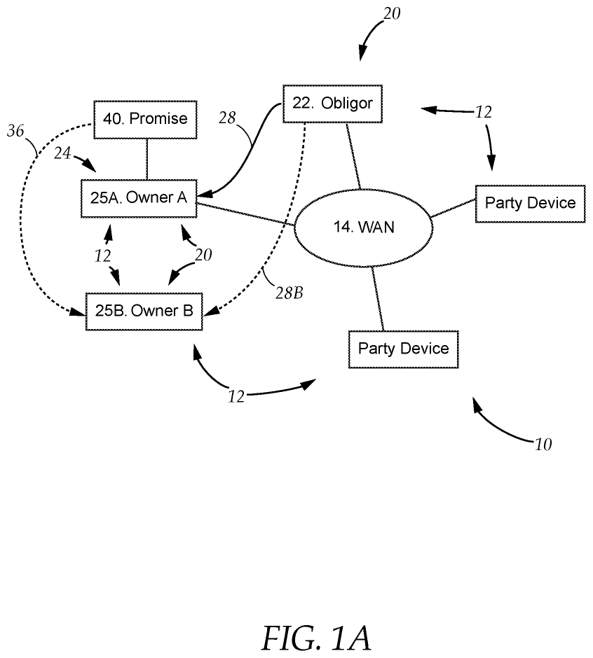

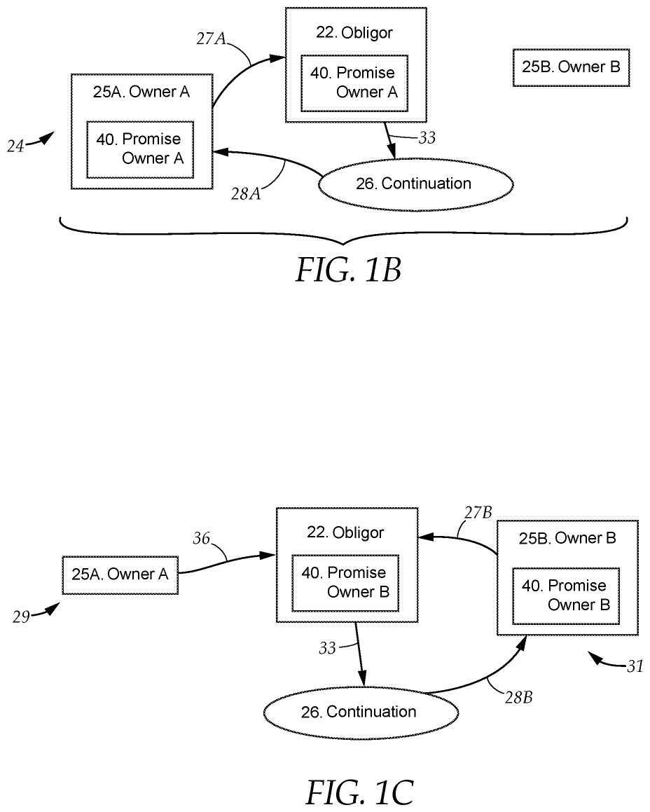

FIG. 1A illustrates a transaction network 10 for creating, authenticating, and invoking a transferable promise 40. The transaction network 10 comprises a plurality of party devices 12 each representing a transaction party 20, which are operably interconnected via a communication network 14, such as the internet. Each party device can be a personal computer, server, mobile device, or any similar computing device. The term “transaction party” as used herein may refer to a party device engaged in a transaction, as well as a user who is accessing the transaction network via the party device. Each transferable promise 40 is associated with at least two transaction parties 20, including an owner 24 which owns the transferable promise, and an obligor 22. The transferable promise 40 defines an obligation by the obligor 22 to perform an obligatory action which will deliver 28 value to the owner 24. Turning now to FIG. 1B while continuing to refer to FIG. 1A, the obligor 22 performs the obligatory action when the owner 24 invokes 27A the transferable promise 40, by signing an invocation request. Each transferrable promise is authenticated by both the obligor 22 and the owner 24 in order to ensure the integrity of the transferrable promise, and further contains a continuation 26 which comprises a sequence of code or other programmed instructions which are carried out when the owner 24 invokes the transferable promise, thereby effecting the obligatory action which the obligor 22 is obliged to perform. The obligatory action may be the transfer of a promised asset to the control of the owner, or the performance of a promised service by the obligor 22. The promised asset may be a digital asset, including a digital representation of a physical asset signifying control or custody over the physical asset by the obligor. By performing the obligatory action, the obligor 22 will deliver 28A the value of the transferrable promise to the owner. These features allow each transferrable promise to be carried out locally amongst the transaction parties 20 of the transaction network 10 without the need for any centralized trusted party or intermediary, because each transferrable promise may only be invoked by its owner 24, and performance of the obligatory action is guaranteed by the obligor 22 via the continuation 26. Furthermore, the transferrable promise 40 may be stored locally by each of the transaction parties 20 associated with the transferable promise 40, and may be directly transmitted between the transaction parties 20.

Turning now to FIG. 10 while continuing to refer to FIGS. 1A-B, an exemplary transfer of an example transferable promise 40 is shown. Each transferable promise 40 can be transferred 36 between two or more transaction parties 20, and the owner 24 may, as a sender 29, transfer the transferable promise 40 to a recipient 31 which becomes the new owner of the transferable promise, by sending a signed transfer request to the obligor. The transfer of the transferable promise 40 is verified and approved by the obligor 22, after which the obligor will perform the obligatory action when the transferable promise 40 is invoked by the new owner. For example, the transferable promise 40 is owned by Owner A 25A, and may be invoked 27A by Owner A 25A to cause the obligor 22 to perform the obligatory action and deliver 28A the value of the transferrable promise 40 to Owner A 25A. Instead of invoking the transferrable promise 40, Owner A 25A may instead initiate a promise transfer as the sender 29 and transfer 36 the transferrable promise to Owner B 25B as the recipient 31. The obligor 22 authenticates the transferrable promise 40 and recognizes Owner B 25B as the new owner, and Owner B 25B may invoke 27B the transferrable promise 40 to cause the obligor 22 to deliver 28B the value of the promise.

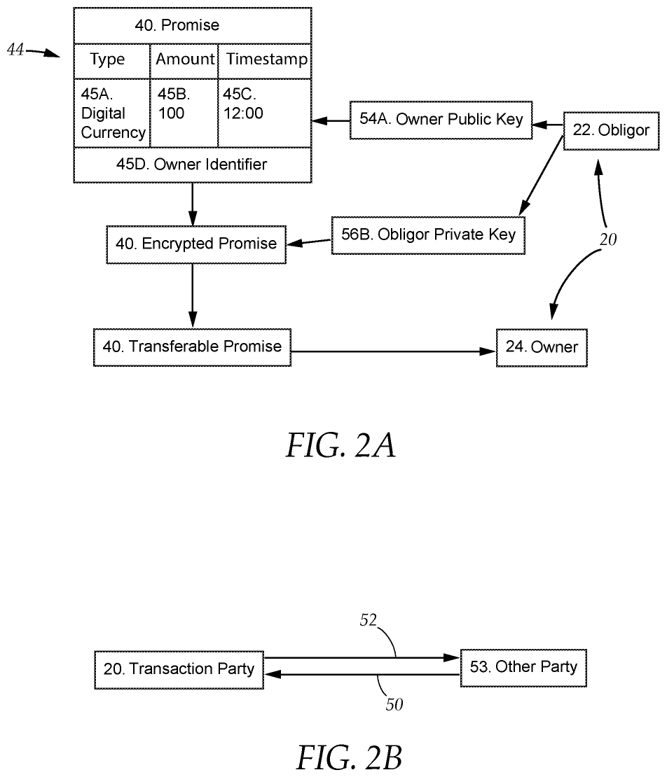

Turning now to FIGS. 2A-B while continuing to refer to FIGS. 1A-C, each transferrable promise 40 has a set of attributes 44 having a plurality of fields comprising a type 45A, an amount 45B, and a timestamp 45C. The attributes may further include an owner field 45D which identifies the owner 24, to whom the value of the transferable promise is to be delivered, however, this is not required. The type 45A and amount 45B define the nature of the obligatory action which the obligor 22 is obligated to perform, while the timestamp 45C records the time at which the transferable promise is defined and created. The type 45A may identify a promised asset such as digital currency, including fiat currencies and cryptocurrencies, securities, a digital representation of a physical asset or custody of the physical asset, as well as any other type of asset of which ownership or control can be transferred digitally to the owner 24. Accordingly, the amount 45B quantifies the promised asset and may describe the amount of digital currency, securities, or individual units of physical assets which the obligor 22 is obligated to deliver to the owner 24. Furthermore, the type 45A may define a promised service or other type of action which the obligor 22 must perform, and the amount 45B may represent the number of instances which the obligor 22 must perform the promised service for the benefit of the owner 24. The service may be performed digitally—for example, the obligor 22 may, such as through the continuation 26, be required to devote a specified measure of computing power to execute computer instructions supplied by the owner or solve a computational problem that offers value to the owner. Where the promised service cannot be performed digitally, such as a service which must be performed physically, the obligor 22 may instead transfer to the owner a token or credit which is redeemable by the owner to effect the performance of the promised service. Alternatively, the obligor 22 may be required to perform (or arrange for an agent or service provider to perform) the promised service upon the invocation of the transferrable promise by the owner 24, or at a time and place specified by the owner 24. Examples of such service may include delivering a physical asset in the custody of the obligor, performance of a project or service such as a haircut, or performance of another specific task by the obligor for the benefit of the owner 24. Invocation of the transferable promise may therefore cause the obligor to dispatch its agent or service provider to perform the promised service.

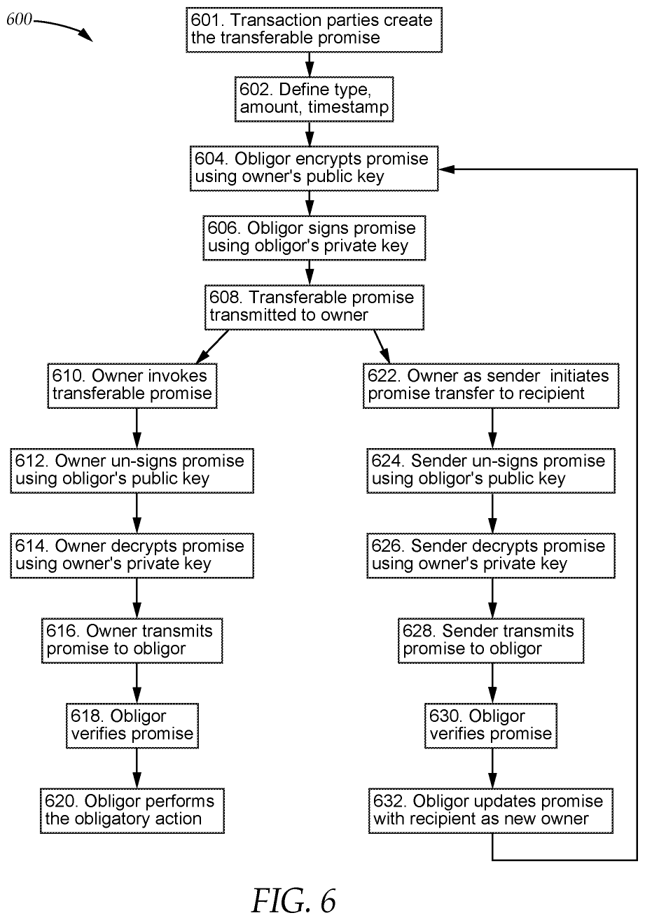

Turning now to FIG. 6 while continuing to refer to FIGS. 2A-B, an exemplary promise creation, transfer, and invocation process 600 is shown. The process 600 begins at step 601 when the transaction parties 20, including the obligor 22 and the owner 24, initiate the process 600 to create the exemplary transferable promise 40 and agree upon the obligation of the obligor 22. At step 602, the attributes 44 of the transferrable promise 40, including the type 45A, the amount 45B, and the timestamp 45C are defined to accurately represent the obligation and the obligatory action which the obligor 22 will be required to perform in order to deliver the value of the transferable promise 40 to the owner 24. For example, the obligatory action may be the transfer of a promised asset, and the type 45A of promised asset 40 may correspond to “digital currency” in the amount 45B of 100 units of the digital currency. The timestamp 45C records the time at which the transferable promise 40 is created, and may be used by the obligor to help identify or distinguish the transferable promise. Next, the process 600 proceeds to step 604, and the obligor encrypts the transferable promise 40. As shown in FIG. 2B, each transaction party 20 has a public key which is visible to other party devices on the transaction network, and a private key which is secret and known only to the transaction party itself. The public key is used by another party 53 to encrypt 50 a transferable promise or message which is sent to the transaction party 20 by the other party 53, and the resulting encrypted transferable promise or message is decrypted 52 by the transaction party 20 using its private key. Similarly, the transaction party's private key is used to sign a transferrable promise or message which is sent by the transaction party 20 to the other party 53, and the signature of the transaction party 20 may be authenticated by the other party 53 using the public key of the transaction party 20. The public-private key paradigm is well known to anyone familiar with prior art.

Returning to FIG. 6 and FIG. 2A, the obligor 22 uses the public key 54A of the owner 24 to encrypt the transferrable promise 40. Next, at step 606, the obligor signs the encrypted transferable promise 40 using the private key 56B of the obligor 22. Encrypting the transferrable promise 40 using the public key 54A of the owner 24 ensures that the transferable promise 40 can only be decrypted by the owner 24 using the owner's private key. Likewise, the signature of the obligor 22, which can be authenticated by any party using the public key of the obligor, signifies that the transferable promise 40 has been approved and consented to by the obligor 22. The integrity of the transferrable transaction 40 is ensured, as the transferrable promise cannot be decrypted, invoked, or transferred by anyone other than the owner 24, and the signature of the obligor 22 ensures that the transferrable promise 40 cannot be tampered with by the owner 24 or any other party, as the transferrable promise 40 cannot be signed without the private key of the obligor 22. The transferable promise 40 is in a secured state once it has been encrypted and signed, and the process 600 proceeds to step 608 and the obligor 22 transmits the transferable promise 40 to the owner 24. The transferable promise 40 is stored locally by the owner 24, and a copy of the transferable promise is also stored locally by the obligor 22 so that the obligor can maintain a record of the obligations in each of the transferrable promises in which it is involved. As the burden of performing the obligation falls upon the obligor, the obligor will ensure that any attempts to double-spend by causing the obligor to perform the obligation twice are prevented. In certain embodiments, the obligor 22 will also include a randomly generated unique number or string (nonce) in each transferable promise at the time of its creation as extra security, to prevent attempts by a third party different from the owner to invoke the promise.

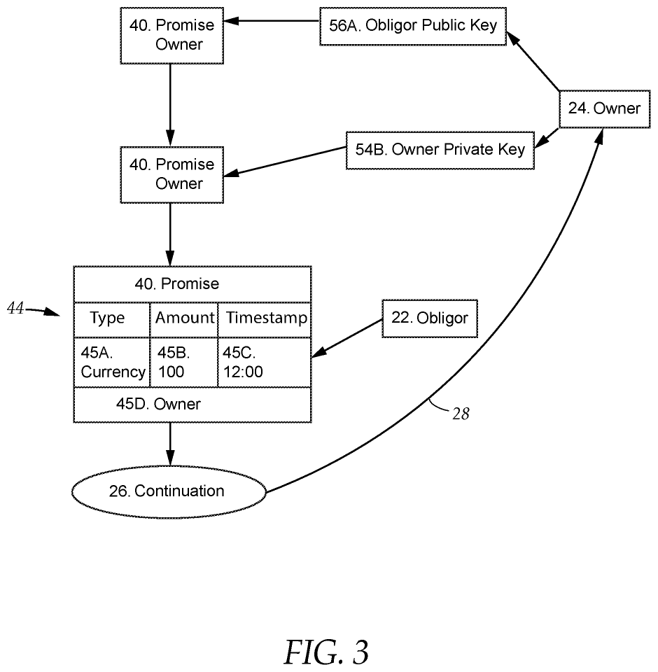

Turning now to FIG. 3 while continuing to refer to FIG. 6, the encrypted and signed transferable promise 40 can be invoked by the owner 24 at any time, at step 610. As part of the invocation process, the owner 24 must present the transferable promise to the obligor 22 and that the invoking transaction party is the owner of the transferrable promise, by signing an invocation request to the obligor. At step 612, the owner 24 proceeds to un-sign the encrypted and signed transferable promise 40 using the obligor's public key 56A. Next, the owner 24 then proceeds to decrypt the encrypted transferable promise 40 at step 614 using the owner's own private key 54B. The owner 24 then transmits the un-signed and decrypted transferable promise 40 to the obligor 22 at step 616. Upon receiving the transferable promise 40 from the owner 24, the obligor 22 proceeds to verify the transferable promise at step 618. As mentioned above, successful decryption of the transferable promise using the owner's private key 54B can constitute evidence of the identity of the owner 24, and the presence of the originally randomly generated nonce can be further proof. The obligor 22 may further verify the transferable promise 40 using a variety of methods, including ensuring that the attributes 44 and fields of the transferable promise 40 received from the owner 24 match those within the copy of the transferable promise which is stored locally by the obligor 22, to prevent the owner from spending the same promise more than once. The obligor 22 may also verify that no alterations have been made to the continuation 26 of the transferable promise 40.

Once the obligor 22 has verified the transferable promise 40, the obligor proceeds to perform the obligatory action required by the transferable promise at step 620, and either delivers the promised asset to the control of the owner 24 or performs the promised service. In the present example, the obligor 22 will transfer 100 units of the digital currency as specified by the amount 45B and type 45A of the transferrable promise 40. Where the transferable promise 40 has a continuation 26, the obligor 22 will execute the continuation 26.

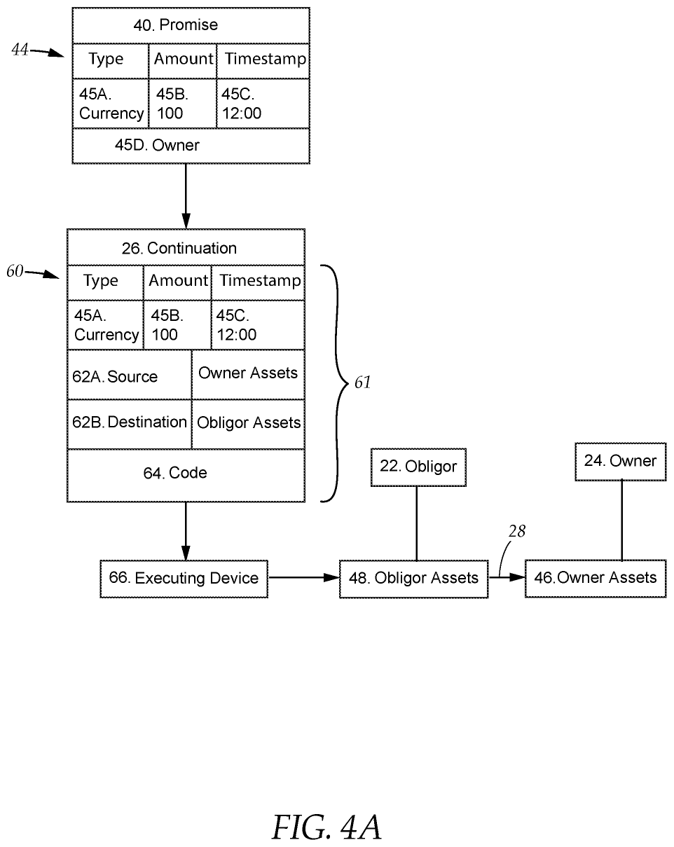

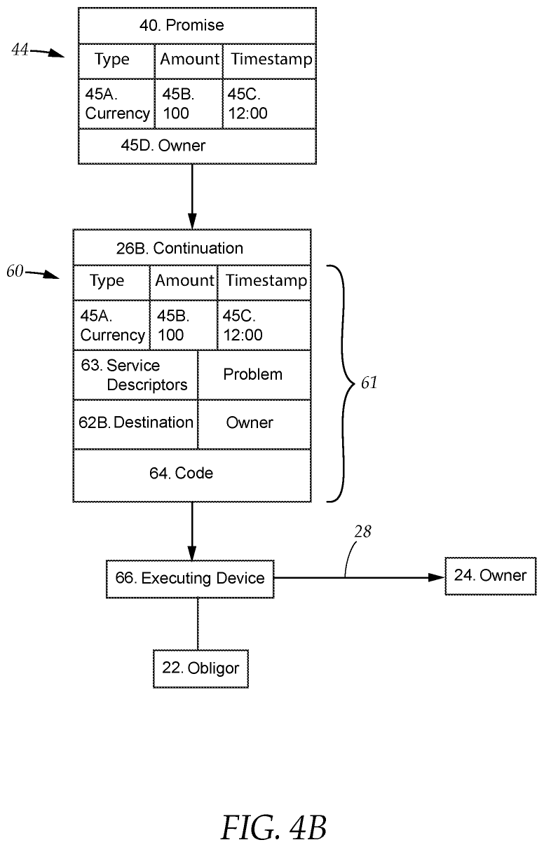

Turning now to FIG. 4A while continuing to refer to FIG. 3, the continuation 26 is the means by which the transferable promise 40 ensures that the obligor 22 will deliver the value of the promise to the owner 24. The continuation 26 is defined when the transferable promise 40 is created, and is stored as data within the transferable promise itself. The continuation 26 is a representation of the obligatory action in a functional programming paradigm, which executes upon the successful invocation of the transferable promise by the owner 24 and causes the obligor 22 to deliver the value of the transferable promise to the owner 24. In general, a continuation is an abstract representation of a control state of a computer program, and is a data structure that represents the computational process of the computer program at a given point in the execution of the program. When the continuation is executed on an executing device 66, which can be one of the party devices (as shown in FIG. 1) or any computer or server capable of executing the computer program and which the obligor 22 can control, the control state is reified on the executing device. Execution of the computer program then occurs at the point defined by the control state of the continuation. Each continuation has a plurality of parameters 60 corresponding to the attributes 44 of the promise which are utilized as runtime environment variables upon execution of the continuation, along with a segment of code 64 which will be executed by the executing device 66. The parameters 60 and the code 64 collectively define the control state 61 of the continuation 26. The parameters 60 may include the type 45A, the amount 45B and/or the timestamp 45C of the transferable promise 40, as well as other information which is necessary to implement the obligatory action. The parameters 60 may further include a source 62A and a destination 62B to facilitate the transfer of the promised asset. For example, the source 62A may define the location of the digital assets 48 of the obligor 22, and the destination 62B may define the location of the digital assets 46 of the owner 24. In the present example, the parameters 60 of the continuation 26 quantify the promised asset as 100 units of digital currency, as indicated by the amount 45B and type 45A of the attributes of the transferable promise 40. The source 62A and destination 62B may therefore indicate the bank routing and account numbers of the obligor 22 and the owner 24 respectively, and the code 64 contains any instructions which may be necessary to facilitate the transfer of 100 units of digital currency from the source 62A to the destination 62B. When the executing device 66 executes the continuation 26, the control state 61 is reified on the executing device, and the instructions within the code 64 are carried out with the parameters 60 as the runtime environment variables. The obligatory action is thus carried out, and the promised asset (of 100 units of digital currency) is deducted from the digital assets 48 of the obligor 22 and added to the digital assets 46 of the owner 24. The continuation may also incorporate parameters given by the owner at the time of invocation. Furthermore, it will be apparent to a person of ordinary skill in the art in the field of the invention, that a continuation may be adapted to transfer any asset which may be transferred digitally, such as by interfacing with payment, clearing, and settlement systems to facilitate the transfer of funds, securities, and other digital assets. A continuation may also provide value to the owner in other ways such as performing an expensive computation or storage operations and giving the owner the result, or generating a state change at the obligor that's valued by the owner.

In addition to the direct transfer of digital assets from the obligor to the owner, a continuation may also be used to transfer control or custody over physical assets or digital representations of physical assets. For example, the continuation may be used to initiate delivery of physical assets to a physical location selected by the owner, and the continuation may be adapted to interface with an ecommerce platform or similar system. In another example, custody over physical assets may be digitally transferred from the obligor to the owner, allowing the owner to take possession of the physical asset at a warehouse or other storage location.

Turning now to FIG. 4B while continuing to refer to FIG. 4A, an example transferable promise 40B is shown, where the obligatory action of the transferable promise 40B is the performance of a promised service. The promised service is calculating a computation problem as indicated by the type 45A. The computation problem may represent a cryptographic problem, an artificial intelligence computation problem, or other problems which require the obligor to perform a significant computation and deliver a result to the owner. The amount 45B may indicate an input of the computation problem to be calculated. When the transferable promise requires the performance of a promised service, the parameters 60 of the continuation 26B may contain at least one service descriptor 63 which defines the promised service. For example, the service descriptor 63 may define the computation problem, along with any input data for the problem, while the code 64 may contain instructions necessary to allow the executing device to calculate the problem and arrive at the result. In some embodiments, the destination 62B may be used to indicate an address, reference, data destination, target, or other location through which the result, once calculated, is to be delivered to the owner 24. Note that the parameters 60 of the continuation 26B are limited to those which are pertinent to the performance of the promised service, and parameters for facilitating the transfer of a promised asset, such as the source 62A, need not be included. Once the transferable promise 40B is successfully invoked by the owner 24, the obligor 22 causes the execution of the continuation 26 and the control state 61 is reified on the executing device 66. The result of the calculated problem is then delivered to the owner 24, and the performance of the promised service is complete.

Another example of a promised service is the fulfillment of a storage request. Upon the successful invocation of the transferable promise, the obligor may store an amount of data specified by the owner in a computer storage device accessible to the owner. The owner may then access and modify the stored data. The attributes of the transferable promise may define the amount as the storage capacity which is to be granted to the owner as well as other conditions regarding the owner's access to the computer storage device, and the continuation is adapted to execute the storage request.

Note that the continuations, including the parameters necessary for their execution, may be implemented in a variety of ways to effect the obligatory action, as will be appreciated by a person of ordinary skill in the art in the field of the invention. The descriptions of continuations provided above are exemplary, and are not intended to limit the features and principles contained in the present disclosure.

In certain embodiments, a transferable promise may contain an obligation for the obligor to perform a series of obligatory actions, allowing the transferable promise to represent a contract. For example, the attributes of the transferable promise may include fields specifying a time period over which the series of obligatory actions is to be performed, as well as a performance interval which specifies when each obligatory action is to be performed within the time period. The transferable promise may therefore be used to represent a contractual obligation by the obligor to transfer a series of specific payments to the owner representing debt owed to the owner by the obligor.

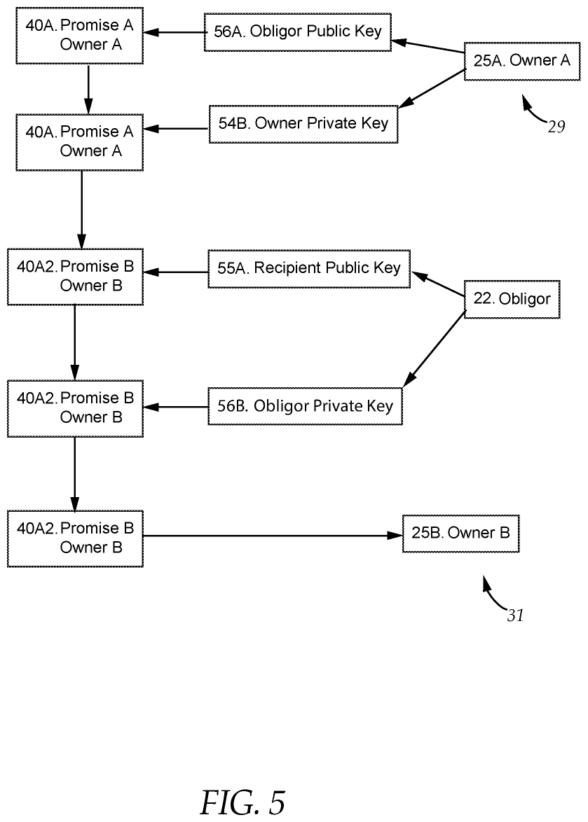

Turning now to FIG. 5 while also returning to FIG. 6, the owner 25A of the transferable promise 40A may act as a sender 29 and transfer the transferable promise 40A to a recipient 31 by initiating a promise transfer request at step 622. The promise transfer occurs in a manner similar to the invocation of a transferable promise as described in steps 610 through 616 of the promise creation, transfer, and invocation process 600. The sender 29 un-signs the encrypted and signed transferable promise 40A at step 624 using the obligor's public key 56A, and decrypts the encrypted transferable promise 40A at step 626 using the sender's (Owner A's) private key 54B. At step 628, the sender proceeds to transmit the decrypted and un-signed transferable promise 40A to the obligor 22 and requests that ownership of the transferable promise 40A be transferred to the recipient 31 (“Owner B” 25B), by sending a signed transfer request to the obligor. Once the obligor 22 receives the transferable promise 40A, the obligor 22 proceeds to verify the transferable promise at step 630. The obligor 22 verifies the promise transfer request in a manner substantially similar to verification of an invocation. As the transferable promise is encrypted using the owner's public key, only the owner may decrypt the transferable promise using the owner's private key. The presence of the obligor's digital signature ensures that the transferable promise 40A has not been altered subsequent to the obligor's signing at the time the transferable promise was created. Once the obligor 22 has verified the transferable promise 40A, the obligor then proceeds to update the transferable promise, including any attributes or code as required, at step 632 using the recipient 31 (“Owner B”) as the new owner. The obligor 22 will also assign a new timestamp to reflect the time which the transferable promise 40A2 is updated with the recipient as the new owner, and may assign a new randomly selected nonce. The transfer of the transferable promise requires the obligor to encrypt and sign it again before the transferable promise is secured and can be invoked or transferred by the new owner. The process 600 returns to step 604, and the obligor 22 encrypts the updated transferable promise 40A2 using the recipient's public key 55A. Next, the obligor 22 signs the updated transferable promise 40A2 using the obligor's private key 56B. Finally, the obligor 22 sends the signed and encrypted transferable promise 40A2 to the recipient 31 at step 608. The recipient 31 is the new owner and can invoke the transferable promise or transfer it to another recipient. The original owner (“Owner A” 25A) is no longer associated with the transferable promise 40A2, and is therefore prevented from making a double-spend attempt in which the sender attempts to invoke the transferable promise it has already transferred to the recipient, because the obligor will no longer honor the original promise.

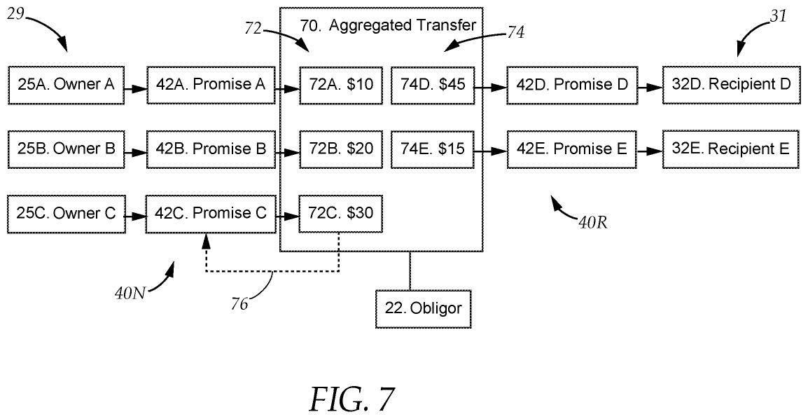

Continuing now to FIG. 7, the transaction network allows transaction parties to initiate an aggregated transfer 70 whereby the aggregated amounts of a plurality of input transferable promises 40N having the same obligor 22 are redistributed amongst a plurality of output transferable promises 40R owned by a plurality of recipients 31. In an aggregated transfer 70, the type of the input and output transferable promises 40N, 40R are the same, and the obligor 22 ensures that the balance of the aggregated amounts of the input transferable promises 40N is equal to the balance of the aggregated amounts of the output transferable promises 40R. The balance of the aggregated amounts of the output transferable promises 40R is fully redistributed amongst the recipients 31 in individual amounts as agreed upon by the transaction parties. In the present example, the plurality of input transferable promises 40N include “Promise A” 42A of “Owner A” 25A, “Promise B” 42B of “Owner B” 25B, and “Promise C” 42C of “Owner C” 25C. The amounts of Promise A, B, and C 72A, 72B, 72C are 10, 20, and 30 respectively and the balance of the aggregated amounts is equal to 60. Upon the initiation of the aggregated transfer, each sender 29 first un-signs and decrypts its input transferable promise before transmitting the input transferable promise to the obligor 22. The obligor 22 may, upon verifying the input transferable promises 40N, create one output transferable promise 40R for each recipient 31. The recipients 31 include “Recipient D” 32D and “Recipient E” 32E, and the obligor 22 creates one output transferable promise for each recipient 31—“Promise D” 42D and “Promise E” 42E. The amounts of “Promise D” and “Promise E” are 45 and 15 respectively and the balance of the aggregate amounts is 60. The obligor 22 will encrypt each output transferable promise 40R using the private key of the recipient 31 and sign each output transferable promise 40R using the obligor's private key.

If any input transferable promise 40N has its amount fully depleted during the aggregated transfer, the obligor need not re-encrypt and re-sign the depleted input transferable promise it can simply be discarded by the transaction parties. However, it is possible for one of the senders 29 to transfer a portion of the amount contained within its input transferable promise. In such cases, the obligor 22 will update the input transferable promise to reflect a residual balance corresponding to the unused portion of the amount of the input transferable promise, and then re-encrypt and re-sign the input transferable promise, thus allowing it to be invoked or transferred by its owner. In the present example, the amounts of “Promise A” 42A and “Promise B” 42B are fully depleted, and these input transferable promises are discarded by the transaction parties. However, the amount of “Promise C” 42C, having the amount of 40, has not been fully depleted by the transfer of 30, and the obligor 22 updates “Promise C” to reflect the residual balance of 10.

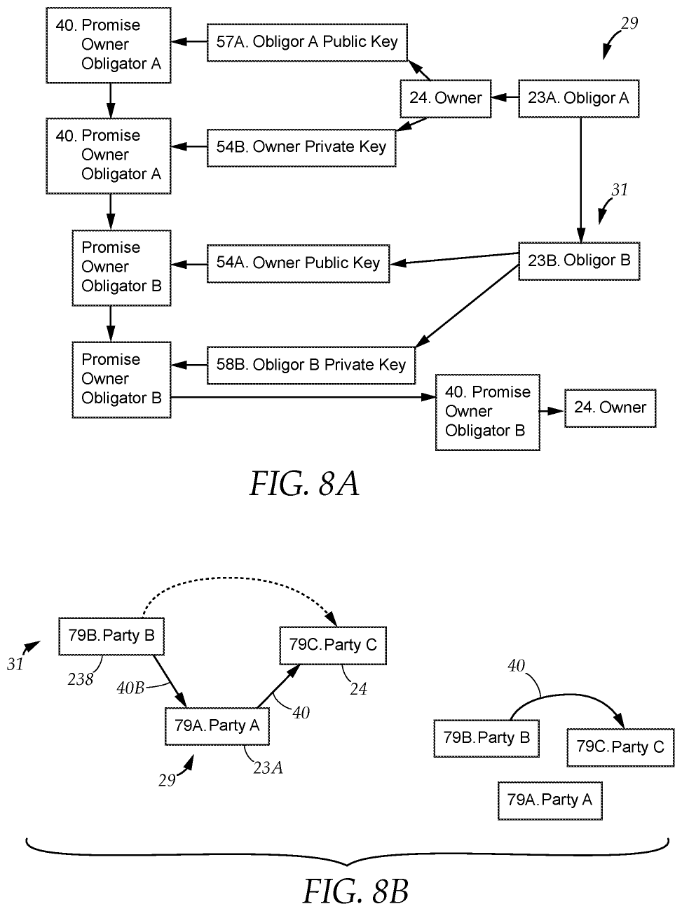

Turning now to FIG. 8A, the obligor of a transferable promise defined as fungible, may, with the consent of the owner, assign its obligation via a promise assignment to another transaction party which then becomes the new obligor of the transferable promise. Assignment of the transferable promise may occur as long as the type of the promise is fungible, and performance of the obligation can be carried out by any obligor satisfying pre-specified conditions. In the present example shown in FIG. 8A, the transferable promise 40 is assigned by “Obligor A” 23A as the sender 29 and “Obligor B” 23B as the recipient 31. Once the promise assignment is initiated, the owner 24 un-signs the encrypted and signed transferable promise 40 using the public key 57A of “Obligor A”, and then decrypts the transferable promise 40 using the owner's private key 54B. The decrypted and un-signed transferable promise 40 is then sent to the recipient 31 (“Obligor B”), which then updates the transferable promise to reflect “Obligor B” 23B as the new obligor. “Obligor B” 23B then proceeds to secure the transferable promise 40 by encrypting the transferable promise 40 using the owner's public key 54A, and signing the encrypted transferable promise 40 using the private key 58B of “Obligor B”. The encrypted and signed transferable promise 40 is then returned to the owner 24 by “Obligor B” 23B. Alternatively, the un-signed and decrypted transferable promise 40 may be sent by the owner to the sender 29 (“Obligor A” 23A), which then sends the transferable promise to the recipient 31 (“Obligor B” 23B), which then updates and secures the transferable promise before returning it to the owner 24.

Assignments of fungible transferable promises can also be carried out using an aggregated assignment process to allow the obligations of a plurality of obligors to be aggregated and redistributed between one or more new obligors, subject to the consent of a single owner 24 of all the transferable promises involved, in a manner analogous to the aggregated transfer process (as shown in FIG. 7). For example, an aggregated promise assignment may have a plurality of input assignment promises owned by one aggregated assignment owner, with the original obligors of each input assignment promise acting as one of a plurality of aggregated assignment senders, and a plurality of aggregated assignment recipients who will become the new obligors once the aggregated assignment is carried out. An output assignment promise is created by each aggregated assignment recipient as its obligor. The balance of the amounts of all the input assignment promises must equal the combined amounts of all the output assignment promises prior to the aggregation assignment, and each new obligor ensures that the owner of every transferable promise assigned to the new obligor will continue to receive the same total amount as it would have prior to the aggregated assignment.

Turning now to FIG. 8B while continuing to refer to FIG. 8A, netting can occur when a transaction party makes a promise assignment when the transaction party is both the obligor of one transferable promise and the owner of another transferable promise of the same type which is fungible, resulting in the ownership balance of the transaction party being netted against its obligation balance. For example, “Party A” 79A, corresponding to the sender 29 shown in the example of FIG. 8A, is the obligor of the transferable promise 40 and is obligated to deliver 10 to “Party C” 79C. “Party A” 79A is also the owner of a second transferable promise 40B, in which “Party B” 79B is the obligor and must deliver $10 to “Party A”. By assigning the transferable promise 40 to “Party B” 79B, “Party B” becomes the new obligor of the obligation to deliver $10 to “Party C” 79C. Netting then occurs, with the result that the obligation of “Party A” which is transferred from “Party A” to “Party B” is netted against the ownership of “Party A” in the obligation which is owed by “Party B”. The ownership balance and obligation balance of “Party A” are equal at $10, resulting in a net balance of $0.

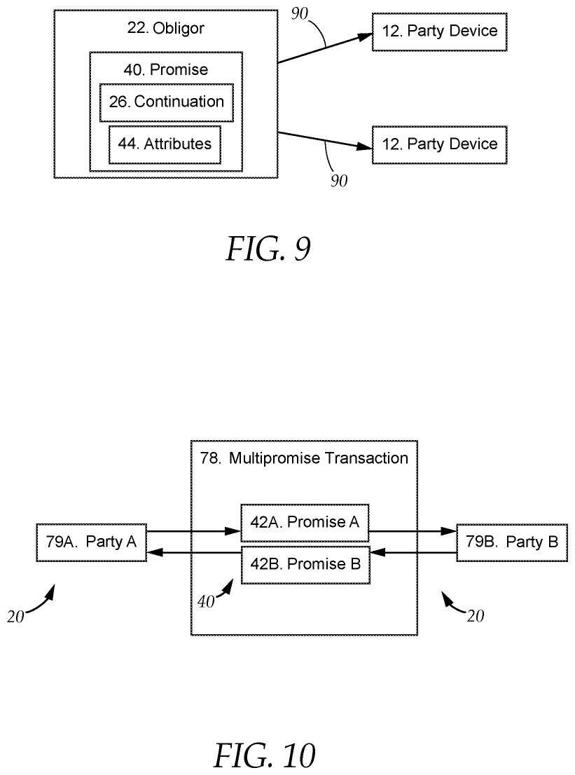

Turning now to FIG. 9, a multi-promise transaction 78 is a collection of transfers of promises to be carried out between the transaction parties 20. A transaction 78 represents an exchange of transferable promises between the transaction parties 20, such that each transaction party is simultaneously transferring ownership of one transferable promise which it owns as well as receiving another transferable promise and becoming its owner. The multi-promise transaction 78 therefore allows assets and/or services of similar value to be exchanged while ensuring that the value of each transferable promise will be delivered to another transaction party, without requiring each transferable promise to be invoked or performed simultaneously. In fact, promises to transfer other promises can be created with the sender as the obligor and the recipient as the owner of this higher level promise. Therefore in the transaction, for each promise to be transferred within the transaction 78, another promise is created which states a transfer of the exchange promise is to be performed from one transaction party to another. Multiple such promises are created simultaneously to effect the transaction. In the present example, the transaction 78 has two transaction parties 20—“Party A” 79A and “Party B” 79B. When the multi-promise transaction is initiated, two transferable promises are created. “Promise A” 42A is created with “Party B” 79B as the owner and “Party A” 79A as the obligor. “Promise B” 42B is created with “Party A” 79A as the owner, and “Party B” as the obligor. The multi-promise transaction 78 is complete only when “Party A” 79A signs “Promise A” 42A and “Party B” 79B signs “Promise B” 42B. Once the multi-promise transaction 78 is complete, each of these promises are invoked and each respective underlying lower level promise will be transferred to its new owner, removed from its old owner and can then be invoked by its new owner at a later time. The transaction is only complete when both promises are signed and transferred to their new owners.

Turning now to FIG. 10 while also referring to FIG. 4A, the transaction network may allow an obligor 22 to publish the transferable promise 40 via a promise publication 90 to allow any party device 12, such as a potential owner or obligor, to view the details of the nature of the transferable promise, including any code constituting the continuation code. The promise publication may display the attributes 44 of the transferable promise 40. For example, when the obligatory action is the transfer of an asset, the type 45A (describing the asset) may suffice to convey the nature of the obligation to other party devices 12. The segment of code 64 within the continuation 26 may also be published, allowing more complex obligations to be conveyed to other party devices by revealing the specific obligatory actions which will be carried out by the executing device 66. To allow a type of promise to be fungible, the promise publication may exclude any information which would specifically identify the owner or the obligor, its balance, bank routing numbers, and other information of a similarly promise specific nature. However, the nature, the type, and the code of the promise is published so that different promises of the same fungible type can be assigned, aggregated, and netted, and the continuation code that is associated with the obligation may be fully specified as well.

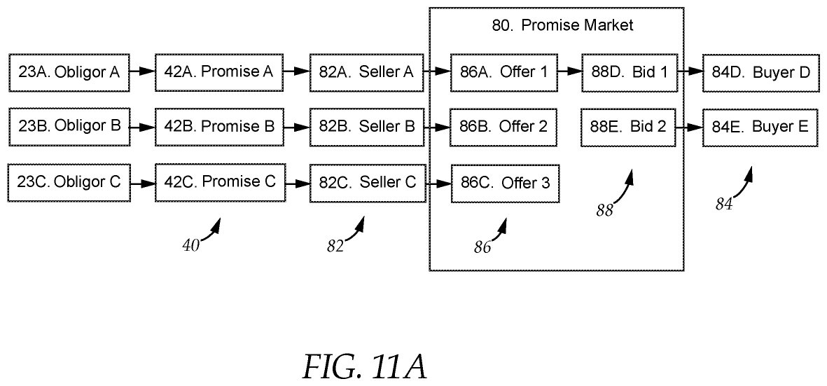

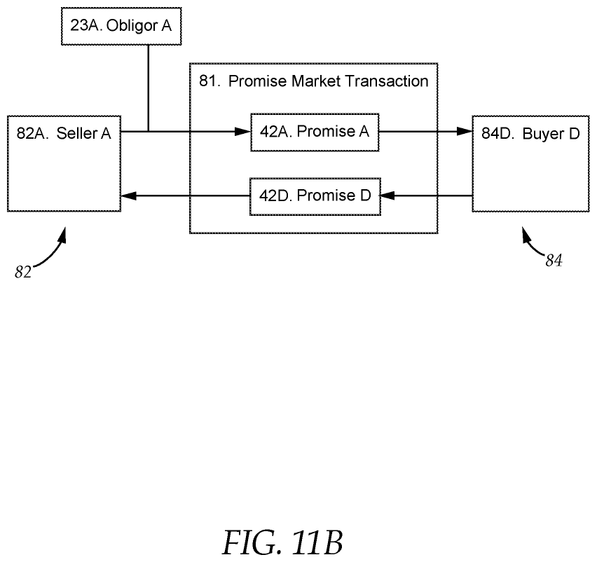

Turning now to FIG. 11A, the transaction network may allow promise market transactions to be conducted between transaction parties acting as sellers 82 and buyers 84. Thus, the transferable promise and its obligation can be assigned a price and traded as an asset. A promise market 80 may be implemented on the transaction network with the sellers 82 and the buyers 84 as the participants. Each seller 82 is the owner of a transferable promise being offered for sale, and each offered transferable promise in the promise market 80 may be of the same type. Each seller 82 may place its transferable promise for sale as an offer 86 with a specified offer price in currency. A promise market transaction is carried out when one of the buyers 84 submits a bid 88 for one of the offers 86 which is greater than or equal to offer price of the offer, creating a match between the bid and the offer. Once the match is created, the seller of the offer will initiate a promise transfer as the sender, to transfer ownership of the offered transferable promise to the buyer as the recipient. The buyer simultaneously transfers the value of its bid to the seller in the form of currency promises.

Turning now to FIG. 11B while continuing to refer to FIG. 11A, to ensure the integrity of the promise market transaction, each promise market transaction may be conducted in a manner similar to a multi-promise transaction (as shown in FIG. 9), with the bidder being one side of the multi-promise transaction as Party A, specifying its intent to transfer a promise of goods or a service as its owner, in exchange for receiving a currency promise; and with the seller being the other side of the multi-promise transaction as Party B, specifying its intent to transfer out of its ownership of a promise in return for ownership of a currency promise. If the fungible promise type is the same, and the bid price is greater than or equal to the offer price, the matched amount by both parties can constitute a valid transaction. The promise market transaction will not be completed until both the offered transferable promise has been signed and transferred by its obligor, and the bid transferable promise has been signed and transferred by the buyer as its obligor. The promise market transaction is completed once both the offered promise and the buyer promise are signed and transferred. For example, in an exemplary promise market transaction 81, “Buyer D” 84D submits “BID 1” 88D which is matched to “Offer 1” 86A sold by “Seller A” 82A. “Seller A” 82A, as the owner of the offered transferable promise “Promise A” 42A, initiates a promise transfer request causing “Obligor A” 23A to prepare “Promise A” 42A for transfer to “Buyer D” 84D. At the same time, “Buyer D” creates “Promise D” 42D as the bid transferable promise with “Buyer D” as its obligor and “Seller A” 82 as its owner. Once both “Promise A” 42A and “Promise D” 42D are signed to their new owners, the exemplary promise market transaction 81 is complete and the promises are sent to their respective owners and can be invoked or transferred at any time.

Note that this example is non-limiting, and the promise market 80 may employ a variety of different ways to match offers and bids. For example, promise market may employ an auction system where the highest bids are matched with offers. Furthermore, the amount contained within the offered transferable promises may be sold as a whole or in portions, and where multiple offered transferable promises have a common obligor, the amounts may be aggregated and sold to one buyer or redistributed amongst multiple buyers in a manner similar to an aggregated transfer as depicted in FIG. 7. A promise market transaction may also be initiated directly between the transaction parties without the need to match bids and offers.

A person of ordinary skill in the art in the field of the invention will appreciate that the features as disclosed in the present disclosure can be adapted to facilitate guaranteed performance of transactions to protect the integrity of any computerized market for transferring assets, goods, and services.

A hash of each promise creation, invocation, transfer, assignment, netting and more complex transactions are broadcast to the transaction network, so that records can be verified by independent third parties post execution. However, the details of the transactions do not require participation from any third party not involved in the promise or transactions, thus allowing distributed transaction processing to occur locally, asynchronously, and in parallel with each other.

In summation, the transferable promise ensures that the obligor will perform the obligation which it owes to the owner of the transferable promise. The obligation is explicitly recognized by the obligor, and the performance of the obligation is further guaranteed by the continuation which is executed upon the invocation of the transferable promise. The transferable promise is secured so that it may only be invoked or transferred by the owner, and each transferable promise is unique in order to prevent any attempt to cause the obligor to perform an obligation that has already been completed. Furthermore, each transferable promise is self-contained and can be created, invoked, or transferred locally between the transaction parties themselves without the need for an intermediary or centralized trusted party. Each promise creation, invocation, transfer, assignment, netting and transaction also only requires the participation of the owners and obligors involved in them, without requiring expensive global consensus as in the case of blockchains. Therefore, the promise method provides a paradigm for distributed transaction processing that is trustless yet highly scalable.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an asynchronous or concurrent programming language such as Go or Javascript, a functional programming language like Haskell, an object oriented programming language such as Java, Smalltalk, C++ or the like and conventional procedural programming languages, such as the “C” programming language or similar programming languages. Other types of languages include XML, XBRL HTML5, Python or Web Assembly. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flow diagrams depicted herein are just one example. There may be many variations to this diagram or the steps (or operations) described therein without departing from the spirit of the disclosure. For instance, the steps may be performed in a differing order and/or steps may be added, deleted and/or modified. All of these variations are considered a part of the claimed disclosure.

In conclusion, herein is presented a system and methods for creating, transferring, and invoking a transferable promise. The disclosure is illustrated by example in the drawing figures, and throughout the written description. It should be understood that numerous variations are possible, while adhering to the inventive concept. Such variations are contemplated as being a part of the present disclosure.

What is claimed is:

1. A method for creating, enforcing, and transferring an enforceable obligation between a plurality of transaction parties, comprising the steps of:
providing a transaction network comprising a plurality of party devices which are operably connected via a network, each party device corresponding to one of the transaction parties;
creating a transferable promise between at least two of the transaction parties, each transaction party having a private key known only to the transaction party and a public key, one of the transaction parties corresponding to an owner and another one of the transaction parties corresponding to an obligor which must perform the obligation, wherein the obligor is adapted to secure the transferable promise by encrypting the transferable promise using the public key of the owner and signing the transferable promise using the private key of the obligor, and wherein the owner is adapted to present the transferable promise to the obligor by un-signing the transferable promise using the public key of the obligor, decrypting the transferable promise using the private key of the owner, and sending the un-signed and decrypted transferable promise to the obligor;
defining the obligation as an obligatory action stored within the transferable promise which the obligor is required to perform;
securing the transferable promise by the obligor by encrypting the transferable promise using the owner's public key and then signing the transferable promise with the obligor's private key;
sending the secured transferable promise to the owner by the obligor;
invoking the secured transferable promise by the owner by un-signing the transferable promise using the obligor's public key and decrypting the transferable promise using owner's private key, and presenting the resulting un-signed and decrypted transferable promise to the obligor;
verifying the transferable promise by the obligor, and ensuring the transferable promise is valid and a double-spend attempt is not present;
and causing the obligor to perform the obligatory action.

2. The method as described in claim 1, wherein:
the step of defining the obligation further comprises the step of defining a plurality of attributes stored within the transferable promise comprising a type and an amount, whereby the type describes the obligatory action and the amount quantifies the obligatory action.

3. The method as described in claim 2, wherein:
the step of defining the obligation is followed by the step of:
defining a continuation stored within the transferable promise which is adapted to enact performance of the obligation, the continuation having a plurality of parameters and a segment of code, whereby the parameters comprise the type and the amount of the transferable promise and a plurality of runtime environment variables, the parameters define a control state; and
the step of causing the obligor to perform the obligatory action further comprises the steps of executing the continuation by the obligor using the obligor's party device, reifying the control state of the continuation on the obligor's party device, and executing the segment of code to perform the obligatory action.

4. The method as described in claim 3, wherein:
the step of defining a continuation further comprises the creating a hash of the code of the continuation and storing the hash within a type field, and publishing the type by making the type field visible to the transaction network.

5. The method as described in claim 4, wherein the step of sending the signed and encrypted transferable promise to the owner by the obligor is followed by the step of:
initiating a promise transfer by the owner, the promise transfer having a transfer sender corresponding to the owner and a transfer recipient which is another transaction party, presenting the secured transferable promise to the obligor by the owner, verifying the un-signed and decrypted transferable promise by the obligor as valid and that no double-spend attempt is present, updating the transferable promise so that the transfer recipient replaces the transfer sender as the owner of the transferable obligation, securing the transferable promise by the obligor by encrypting the promise with the public key of the transfer recipient and signing the encrypted promise using the obligor's private key, and completing the promise transfer by sending the secured transferable promise to the transfer recipient by the obligor, whereby the transferable promise is invocable by the transfer recipient as the owner.

6. The method as described in claim 5, wherein the step of initiating a promise transfer is followed by the step of:
initiating a promise assignment by the obligor, the promise assignment having an assignment sender corresponding to the obligor and an assignment recipient corresponding to another transaction party, presenting the secured transferable promise to the owner by the sending obligor, verifying the un-signed and decrypted transferable promise by the owner, sending the unsigned and decrypted transferable promise to the assignment recipient by the obligor acting as the assignment sender, updating the transferable promise so that the assignment recipient replaces the assignment sender as the obligor of the transferable obligation, securing the transferable promise by the assignment recipient as the obligor by encrypting the promise using the owner's public key and signing the encrypted promise using the recipient obligor's private key, and completing the promise assignment by sending secured transferable promise to the owner by the assignment recipient as the obligor, whereby the assignment recipient is required to perform the obligation as the obligor.

7. The method as described in claim 6, wherein the steps as recited are followed by the steps of:
initiating an aggregated promise transfer having a plurality of input transferable promises which share one aggregated promise obligor, a plurality of aggregated promise senders, and a plurality of aggregated promise recipients, whereby the owner of each input transferable promise corresponds to one of the aggregated promise senders, and the aggregated promise obligor is the obligor of all the input transferable promises, whereby the aggregated promise transfer is consented to by all involved transfer parties;
presenting each input transferable promise to the aggregated promise obligor by each aggregated promise sender;
verifying each input transferable promise by the aggregated promise obligor;
creating an output transferable promise for each aggregated promise recipient by the aggregated promise obligor whereby the owner of each output transferable promise is one of the aggregated promise recipients, setting the amount of each output transferable promise so that the total of the amounts of the output transferable promises is equal to the total of the amounts of the input transferable promises, and defining the continuation of each output transferable promise; and
securing each output transferable promise by the aggregated promise obligor whereby each output transferable promise is encrypted using the public key of the owner of each output transferable promise and signed using the private key of the aggregated promise obligor, and sending each secured output transferable promise to its owner.

8. The method as described in claim 7, wherein the steps as recited are followed by the steps of:
initiating an aggregated promise assignment having a plurality of input assignment promises which share one aggregated assignment owner, a plurality of aggregated assignment senders, and a plurality of aggregated assignment recipients, whereby the obligor of each input aggregated assignment promise corresponds to one of the aggregated assignment senders, whereby the aggregated promise assignment is consented to by all involved assignment parties;
presenting each input assignment promise to the aggregated assignment owner by each assignment sender;
verifying each input assignment promise by its aggregated assignment owner;
creating an output assignment promise for each output assignment recipient whereby the obligor of each output assignment promise is the aggregated assignment recipient which created it, setting the amount of each output assignment promise so that the total of the amounts of the output assignment promises is equal to the total of the amounts of all the input assignment promises, and defining the continuation of each output assignment promise; and
securing each output assignment promise by its obligor whereby each output transferable promise is encrypted using the public key of the aggregated assignment owner and signed using the private key of the aggregated assignment recipient, and sending each secured output aggregated transferable promise to the aggregated assignment owner.

9. The method as described in claim 8, wherein the steps as recited further comprise the steps of:
initiating a multi-promise transaction between at least a first transaction party and a second transaction party, comprising a transfer of a first promise from the first transaction party to the second transaction party, and a transfer of a second promise from the second transaction party to the first transaction party, securing the transfers of the first and second promises by encoding each as a new promise to transfer the first and second promises upon request by the respective owner of each promise, and simultaneously sending both the first and second transfer promises to the respective owners only when both the first and second promises are secured, thus enforcing a transaction mechanism that requires an exchange of digital assets amongst all involved transaction parties;

10. The method as described in claim 9, wherein the step of invoking the transferable promise by the owner is preceded by the step of:
initiating a promise market transaction between two transaction parties comprising a seller and a buyer whereby the seller is the owner of the transferable promise, and the buyer is the owner of a currency promise to deliver currency or a crypto-currency, transferring the transferrable promise from the seller to the buyer, and simultaneously transferring the currency promise from the buyer to the seller.

11. The method as described in claim 10, wherein:
the obligation is the delivery of a digital asset;
the step of defining the obligation comprises defining the obligation as an obligatory action stored within the transferable promise which the obligor is required to perform to deliver the digital asset to the owner, defining a plurality of attributes stored within the transferable promise comprising a type and an amount, whereby the type describes the digital asset and the amount quantifies the digital asset; and
the step of causing the obligor to perform the obligatory action further comprises the step of delivering the digital asset to the owner.

12. The method as described in claim 11, wherein:
the digital asset is digital or fiat currency; and
the step of causing the obligor to perform the obligatory action further comprises the step of deducting the amount of the digital asset from a digital asset balance maintained by the obligor and adding the amount of the digital asset to a destination digital asset balance specified by the owner.

13. The method as described in claim 12, wherein:
the digital asset is a digital representation indicating custody of a physical asset; and
the step of causing the obligor to perform the obligatory action further comprises the step of granting to the owner a right to take custody of the physical asset.

14. The method as described in claim 10, wherein:
the obligation is a service; and
the step of defining the obligation comprises defining the obligation as an obligatory action stored within the transferable promise which constitutes the service, defining a plurality of attributes stored within the transferable promise comprising a type and an amount, whereby the type describes the service and the amount quantifies the performance of the service.

15. The method as described in claim 14, wherein:
the step of defining the obligation further comprises the steps of defining the type as a complex computation problem, and defining a plurality of problem variables within the attributes; and
the step of causing the obligor to perform the obligatory action further comprises the step of executing the segment of code to perform the obligatory action by calculating the complex computation problem and delivering a result to the owner.

16. The method as described in claim 15, wherein:
the party device of the obligor has a computer storage device which is accessible to other party devices via the network;
the step of defining the obligation further comprises the steps of defining the type as a storage request, and defining the amount as a data storage capacity; and
the step of causing the obligor to perform the obligatory action further comprises the step of executing the segment of code to perform the obligatory action by enabling the owner to access the computer storage device and store data therein.
